(19) United States
(12) Patent Application Publication
(10) Pub. No.: US 2014/0214786 A1
(43) Pub. Date: Jul. 31, 2014

(54) INTERNET SEARCH APPARATUS

(71) Applicant: Alpine Electronics, Inc., Tokyo (JP)

(72) Inventors: Yusuke Sato, Iwaki (JP); Kaname Kimura, Iwaki (JP)

(73) Assignee: Alpine Electronics, Inc., Tokyo (JP)

(21) Appl. No.: 14/096,890

(22) Filed: Dec. 4, 2013

(30) Foreign Application Priority Data
Jan. 31, 2013 (JP) 2013-016612
May 28, 2013 (JP) 2013-111639

(51) Int. Cl. G06F 17/30

(52) U.S. Cl. CPC G06F 17/30864
USPC 707/706

(57) ABSTRACT

An Internet search apparatus includes a current location detection unit configured to detect a current location, an administrative district name acquisition unit configured to acquire a name of an administrative district to which the current location belongs, and an information search unit configured to perform an Internet search and display a search result in the form of a list such that a web page that does not include the administrative district name is excluded.

### PRIORITY CLAIM

This application claims the benefit of Japanese Patent Application No. 2013-016612, filed on Jan. 31, 2013 and Japanese Patent Application No. 2013-111639, filed on May 28, 2013, both of which are incorporated by reference herein in their entirety.

### BACKGROUND

1. Field of the Invention

The present invention relates to an Internet search apparatus, and more particularly, to a technique for searching for web pages on the Internet using a search engine.

2. Description of the Related Art

A search engine is known as a tool for searching for information on the Internet. In the search using the search engine, a keyword is input in a box called a search window, and the search is performed using the input keyword. More specifically, in the search using the search engine, web pages including a word matching the keyword input in the search window are extracted, and the extracted web pages are displayed as a search result in the form of a list (and more specifically, a list of titles or captions).

However, there may be a huge number of web pages including the word matching the given keyword, and many of the extracted web pages are likely not to be related to information a user is really seeking. Furthermore, extracted web pages are displayed in a list in order according to an algorithm of the search engine, and thus web pages the user is seeking are not necessarily displayed at high positions in the list.

In view of the above, a technique has been proposed to sort web pages in a list such that a user is allowed to efficiently find necessary information (see, for example, WO 2009/150732, Japanese Unexamined Patent Application Publication No. 2012-68908). In the technique disclosed in WO 2009/150732, the order of web pages is sorted according to the number of accesses or other factors in terms of usage provided by an information providing server in response to a query. In the technique disclosed in Japanese Unexamined Patent Application Publication No. 2012-68908, information acquired via an Internet search is sorted according to frequently-appearing character strings extracted from a document file.

A typical purpose of searching for information on the Internet using a search engine is to buy merchandise. In this case, a search is performed using a name of merchandise a user wants to buy as a keyword to find a store selling the merchandise. Recently, online stores have become very popular. Therefore, when a search is performed simply by using the merchandise name as a keyword, many web pages of online stores are retrieved.

Buying merchandise from an online store is convenient. However, there are still many people who prefer to buy merchandise after actually seeing it at a store. When such people try to search for brick-and-mortar stores selling merchandise they want, a resultant list of retrieved web pages is likely to include many web pages of online stores, which makes it difficult to efficiently find web pages of brick-and-mortar stores.

To solve the difficulty described above, it is an object of embodiments of the present invention to provide a technique to efficiently find a web page of a brick-and-mortar store selling merchandise from a list of web pages obtained as a result of an Internet search.

### SUMMARY

According to embodiments of the present invention, to achieve the object described above, when an Internet search is performed, a name of an administrative district to which a current location belongs is acquired, and a list of web pages obtained as a result of the Internet search is displayed such that web pages that do not include the acquired administrative district are excluded from the list.

In another aspect of the present invention, a list of web pages obtained as a result of an Internet search is displayed such that web pages including a name of an online store are excluded from the list.

According to embodiments of the present invention, as described above, the search result of web pages is narrowed according to the administrative district to which the current location belongs. Online stores are not supposed to sell merchandises to only people living in particular areas, and thus, in most cases, web pages or their titles or captions associated with online stores do not include a description of a name of a particular administrative district. Therefore, by narrowing the search result of web pages such that web pages that do not include an administrative district that are excluded from the search result, many web pages associated with online stores are removed from the search result, and web pages associated with brick-and-mortar stores and including an administrative district in titles, captions, or bodies of web pages are likely to be displayed at high positions in the list of retrieved web pages. This allows a user to more efficiently find a web page of a brick-and-mortar store selling merchandise the user wants to get, from the list of web pages displayed as a result of the Internet search.

According to another aspect of the present invention, a web page including a name of an online store is excluded from a search result such that web pages of brick-and-mortar stores are likely to be displayed at higher positions in a list of retrieved web pages. This allows a user to more efficiently find a web page of a brick-and-mortar store selling merchandise the user wants to get from the list of web pages displayed as a result of the Internet search.

### BRIEF DESCRIPTION OF THE DRAWINGS

FIG. 1 is a block diagram illustrating an example of a functional configuration of an Internet search apparatus according to a first embodiment.

FIGS. 2A and 2B are diagrams each illustrating an example of a manner in which an information search unit displays a search result on a display (in the form of a list of retrieved web pages).

FIG. 3 is a flow chart illustrating operation of an in-vehicle apparatus according to the first embodiment.

FIG. 4 is a block diagram illustrating a functional configuration of an Internet search apparatus according to a second embodiment.

FIG. 5 is a block diagram illustrating a functional configuration of an Internet search apparatus according to a third embodiment.

FIG. 6 is a flow chart illustrating operation of an in-vehicle apparatus and a smartphone according to the third embodiment.

FIG. 7 is a block diagram illustrating a functional configuration of an Internet search apparatus according to a fourth embodiment.

FIG. 8 is a diagram illustrating operation of h an administrative district name acquisition unit, according to the fourth embodiment.

FIG. 9 is a block diagram illustrating a functional configuration of an Internet search apparatus according to a fifth embodiment.

FIG. 10 is a diagram illustrating an example of a manner in which an administrative district name acquisition unit operates according to the fifth embodiment.

### DETAILED DESCRIPTION

### First Embodiment

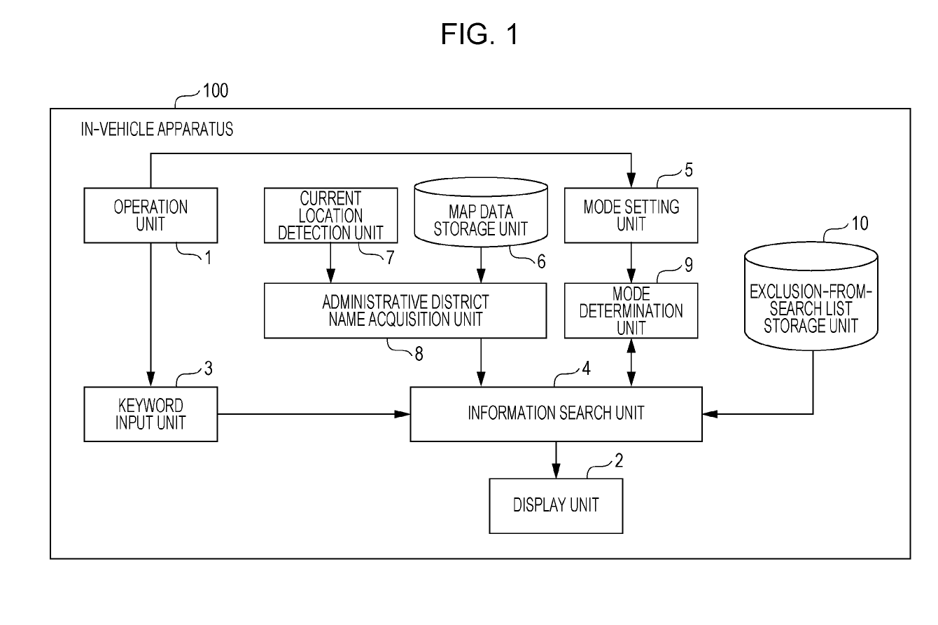

A first embodiment of the present invention is described below with reference to drawings. FIG. 1 is a block diagram illustrating an example of a functional configuration of an Internet search apparatus according to the first embodiment. In FIG. 1, it is assumed by way of example that the Internet search apparatus according to the first embodiment is installed in an in-vehicle apparatus 100.

As illustrated in FIG. 1, the Internet search apparatus (in-vehicle apparatus 100) according to the first embodiment includes, as functional units, an operation unit 1, a display unit 2, a keyword input unit 3, an information search unit 4, a mode setting unit 5, a map data storage unit 6, a current location detection unit 7, an administrative district name acquisition unit 8, a mode determination unit 9 and an exclusion-from-search list storage unit 10.

Note that the blocks 3 to 5 and 7 to 9 described above may be realized by hardware, a digital signal processor (DSP), or software. For example, in a case where the blocks are realized by software, such functional blocks 3 to 5 and 7 to 9 are actually realized such that a computer including a CPU, a RAM, a ROM, and the like is provided and the functions are realized by executing a program stored in the RAM or the ROM by the CPU.

The operation unit 1 is a unit used by a user to perform an operation related to an Internet search. The operation unit 1 may be realized, for example, by a touch panel. The operation unit 1 is used, for example, to input a keyword in an Internet search or to input a command to set a brick-and-mortar store search mode as will be described later.

The display unit 2 is a unit for displaying information associated with an Internet search. The display unit 2 may be realized, for example, by a liquid crystal display. For example, the display unit 2 displays a search window for inputting a keyword for an Internet search or a result of the Internet search. The search window and the search result are both provided by the information search unit 4.

The keyword input unit 3 is for inputting a keyword such that when the keyword is input in the search window by a user by operating the operation unit 1, the input keyword is supplied to the information search unit 4. The information search unit 4 searches for web pages on the Internet using the keyword input via the keyword input unit 3. Retrieved web pages are displayed as a search result on the display unit 2 in the form of a list of web pages (and more specifically, a list of titles and captions thereof).

In the present embodiment, the information search unit 4 changes the Internet search method depending on whether the brick-and-mortar store search mode is specified or the brick-and-mortar store search mode is not specified (but the normal search mode is specified). In the case where the normal search mode is specified, the information search unit 4 searches for web pages on the Internet using a keyword input via the keyword input unit 3 as described above, and the information search unit 4 displays retrieved web pages as a search result in the form of a list on the display unit 2. The search method for the case where the brick-and-mortar store search mode is specified will be described later.

The mode setting unit 5 sets the normal search mode or the brick-and-mortar store search mode as the search mode in the Internet search apparatus according to an operation of the operation unit 1 by a user. For example, the normal search mode may be set in an initial state. When a user specifies the brick-and-mortar store search mode via a particular setting screen, the mode setting unit 5 changes the search mode into the brick-and-mortar store search mode from the normal search mode.

The map data storage unit 6 is a unit configured to store map data. The map data storage unit 6 may be realized, for example, by a storage medium such as a hard disk or the like. For example, the map data is used by the navigation apparatus in route guidance, and the map data may include road data, facility data, and/or the like. The map data may include position information such as latitude/longitude information and may further include area information such as administrative district information.

The current location detection unit 7 is a unit configured to detect the current location of a vehicle at predetermined intervals. The current location detection unit 7 includes an autonomous navigation sensor, a GPS receiver, a location calculation CPU, and the like. The autonomous navigation sensor includes a vehicle speed sensor (distance sensor) configured to output one pulse every particular travel distance thereby detecting a total travel distance of the vehicle, and also includes an angular velocity sensor (relative direction sensor) such as a vibrating gyroscope configured to detect a rotation angle of the vehicle. The autonomous navigation sensor detects the relative position and the direction of the vehicle using the vehicle speed sensor and the angular velocity sensor.

The location calculation CPU is configured to calculate the absolute location (estimated vehicle location) and the direction of the vehicle based on the data associated with the relative location and the direction of the vehicle output from the autonomous navigation sensor. The GPS receiver is configured to receive, via a GPS antenna, radio waves transmitted from a plurality of GPS satellites, and calculate an absolute location and a direction of the vehicle based on a 3-dimensional or 2-dimensional position measurement (note that the vehicle direction is calculated from the current location of the vehicle and the location one sampling time ΔT before).

The administrative district name acquisition unit 8 is configured to acquire a name of an administrative district to which the current location detected by the current location detection unit 7 belongs, based on the map data stored in the map data storage unit 6. Note that in the acquisition of a name of an administrative district, units of administrative districts may be specified arbitrarily. For example, prefectures, cities, towns, villages, or the like may be specified as units administrative districts. Any geographical area or geopolitical area may be defined to be an administrative district. Such a geographical area or geopolitical area may be predetermined or predefined, or may vary dynamically or may be adjusted by the user.

The mode determination unit 9 determines the search mode set by the mode setting unit 5 in response to an inquiry from the information search unit 4. More specifically, in the present embodiment, the mode determination unit 9 determines whether the brick-and-mortar store search mode is set as the search mode to search for brick-and-mortar stores selling merchandises. The mode determination unit 9 notifies the information search unit 4 of a determination result.

In a case where the determination made by the mode determination unit 9 is that the brick-and-mortar store search mode is set as the search mode, the information search unit 4 performs an Internet search and displays, on the display unit 2, a search result in the form of a list excluding any web page that does not include a description of the administrative district acquired by the administrative district name acquisition unit 8. More specifically, the information search unit 4 may exclude any web page that does not include a description of the administrative district acquired by the administrative district name acquisition unit 8 or may exclude any web page whose title or caption does not include a description of the administrative district acquired by the administrative district name acquisition unit 8.

Depending on web pages of online stores, an area where merchandise is produced is described by an administrative district. However, even in web pages of online stores including a description of an area where merchandise is produced, the description appears, in most cases, in a body of a web page of an online store, and the administrative district where the merchandise is produced does not appear, in most cases, in a title or a caption of the web page in a list of search result. Therefore, to efficiently exclude web pages of online stores, it is desirable to exclude web pages that do not include an administrative district in a title of a caption thereof.

When the brick-and-mortar store search mode is set as the search mode, web pages including no description of an administrative district may be excluded, for example, as follows. The information search unit 4 adds a name of an administrative district acquired by the administrative district name acquisition unit 8 to a keyword input via the keyword input unit 3 thereby producing a combination of keywords. The information search unit 4 then searches for information on the Internet according to the combination of keywords, and displays a list of retrieved web pages as a search result on the display unit 2. That is, the information search unit 4 searches for web pages which include both the keyword input via the keyword input unit 3 and the administrative district acquired by the administrative district name acquisition unit 8.

The exclusion-from-search list storage unit 10 is a unit for storing, in advance, an exclusion-from-search list describing names of web pages to be excluded from retrieved web pages when the brick-and-mortar store search mode is set as the search mode. The exclusion-from-search list storage unit 10 may be realized, for example, by a storage medium such as a hard disk. Names of online stores may be described as names of web pages to be excluded in the exclusion-from-search list. Names of video sites may be further included in the exclusion-from-search list.

The information search unit 4 displays the search result in the form of a list such that any web page that does not include a description of the administrative district name acquired by the administrative district name acquisition unit 8 and any web page including any online store name stored in the exclusion-from-search list storage unit 10 are excluded. In a case where names of video sites are stored in the exclusion-from-search list storage unit 10, the information search unit 4 displays the list of retrieved web pages such that any web page including a description of any video site name is further excluded.

More specifically, the information search unit 4 searches for web pages that include both the keyword input via the keyword input unit 3 and the administrative district acquired by the administrative district name acquisition unit 8 and that do not include any online store name and any video site name stored in the exclusion-from-search list storage unit 10, and the information search unit 4 displays a list of retrieved web pages as a search result on the display unit 2.

Note that the search method described above is merely an example, and the invention is not limited to this search method. For example, first, a search may be performed using a keyword input via the keyword input unit 3 as in a case where the normal search mode is set as the search mode. Thereafter, from resultant retrieved web pages, any of the following web pages may be excluded: any web page that does not include a description, in its title or caption, of the name of the administrative district acquired by the administrative district name acquisition unit 8; and any web page that includes a description, in its title or caption, of an online store name or a video site name stored in the exclusion-from-search list storage unit 10.

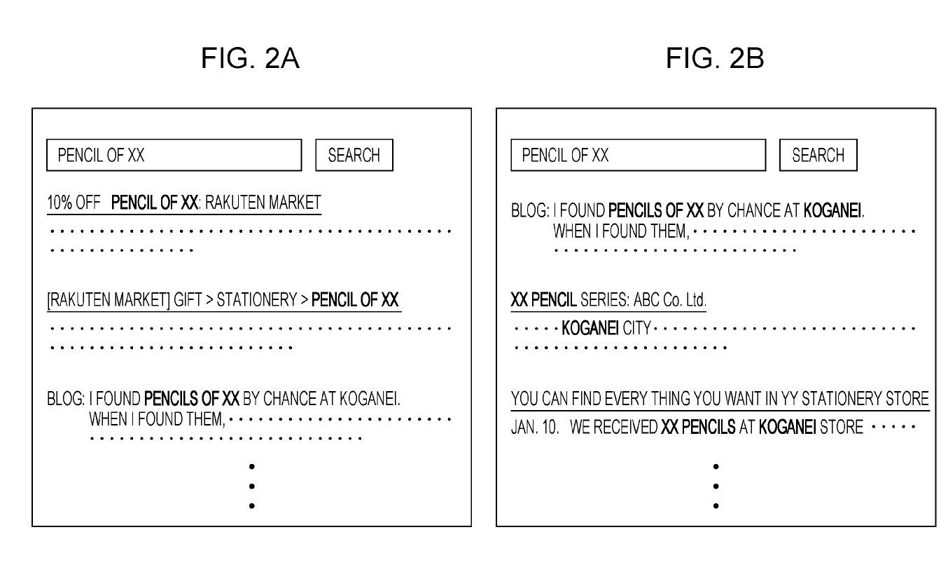

FIGS. 2A and 2B are diagrams illustrating examples of manners in which search results are displayed (in the form of lists of web pages) on the display unit 2 by the information search unit 4. FIG. 2A illustrates an example of a search result in the normal search mode, and FIG. 2B illustrates an example of a search result in the brick-and-mortar store search mode. In these examples, it is assumed that “pencil of xx” was input as keywords in the keyword input unit 3, and “Koganei city” was acquired by the administrative district name acquisition unit 8 as the name of administrative district to which the current location of the vehicle belongs.

In the example of the normal search mode illustrated in FIG. 2A, the search result includes web pages of both online stores and brick-and-mortar stores. In contrast, in the example of the brick-and-mortar store search mode illustrated in FIG. 2B, the search result induces only web pages in which “Koganei” is described as a name of an administrative district in their tiles or captions. Note that in the search result, any web page is excluded that includes a description, in its title or caption, of an online store name or a video site name specified to be excluded. As a result, a web page associated with a brick-and-mortar store located in Koganei city and selling the “pencils of xx” is likely to be displayed at a high position in the list. This makes it easier for a user to find a web page of a brick-and-mortar store the user is seeking.

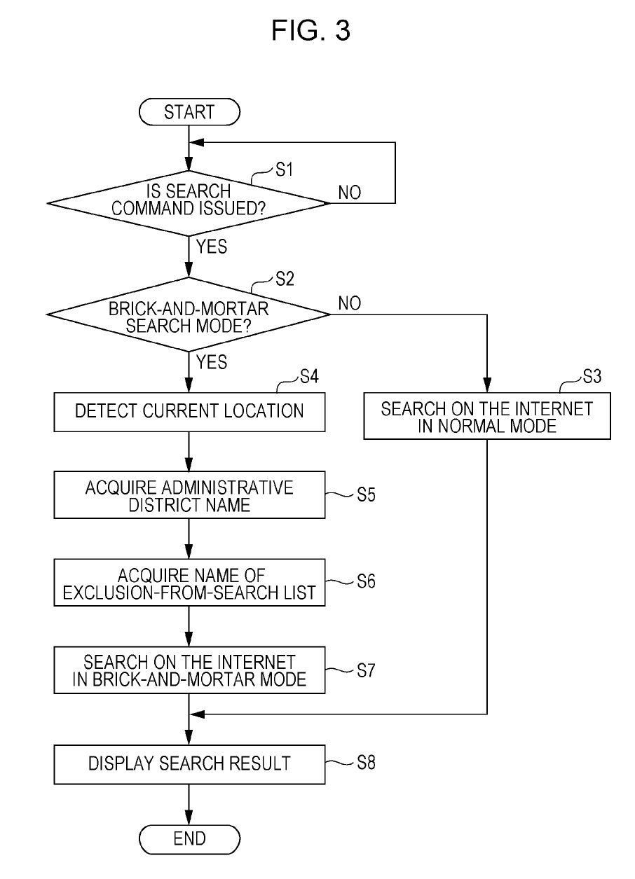

FIG. 3 is a flow chart illustrating an example of an operation of the in-vehicle apparatus 100 (Internet search apparatus) configured in the above-described manner according to the first embodiment. The operation illustrated in the flow chart of FIG. 3 starts when a function of Internet search is started in the in-vehicle apparatus 100.

First, the keyword input unit 3 determines whether a search command is issued by the information search unit 4 after a keyword is input in the search window displayed on the display unit 2 (step S1). In a case where the search command is not issued, the determination in step S1 is repeated. On the other hand, in a case where the search command is issued, the keyword input unit 3 supplies the input keyword to the information search unit 4 and notifies the information search unit 4 that the search command is issued.

Next, in response to an inquiry from the information search unit 4, the mode determination unit 9 determines whether the brick-and-mortar store search mode is set as the search mode (step S2). In a case where the determination made by the mode determination unit 9 is that the brick-and-mortar store search mode is not set as the search mode, that is, the normal search mode is set as the search mode, the information search unit 4 performs an Internet search in the normal mode using the keyword input via the keyword input unit 3 (step S3), and displays a search result in the form of a list on the display unit 2 (step S8).

On the other hand, in a case where the determination made by the mode determination unit 9 is that the brick-and-mortar store search mode is set as the search mode, the current location detection unit 7 detects the current location of the vehicle at this specific time (step S4). The administrative district name acquisition unit 8 acquires a name of an administrative district to which the current location detected by the current location detection unit 7 belongs, based on map data stored in the map data storage unit 6, and the administrative district name acquisition unit 8 supplies the acquired administrative district name to the information search unit 4 (step S5).

Furthermore, the information search unit 4 acquires, from the exclusion-from-search list storage unit 10, names of online stores and names of video sites specified as to be excluded (step S6). Thereafter, the information search unit 4 searches for web pages that include both the keyword input via the keyword input unit 3 and the administrative district name acquired by the administrative district name acquisition unit 8 and that include neither the online store name nor the video site name stored in the exclusion-from-search list storage unit 10 (step S7), and the information search unit 4 displays a search result in the form of a list on the display unit 2 (step S8). Thus, the operation illustrated in the flow chart of FIG. 3 is ended.

In the first embodiment, as described in detail above, when the brick-and-mortar store search mode is set as the search mode to search for brick-and-mortar stores selling merchandises, a search result is displayed in the form of a list excluding web pages that do not include a name of an administrative district to which the current location of the vehicle belongs. Furthermore, in the first embodiment, when the brick-and-mortar store search mode is set as the search mode, any web page including a name of an online store or a video site is also excluded from the list of resultant retrieved web pages.

In the first embodiment, as described above, the search result of web pages is narrowed according to the administrative district name, and thus many web pages of online stores are removed from the search result, which allows web pages of brick-and-mortar stores including the administrative district name to be displayed at high positions in the list of retrieved web pages. Furthermore, any web page including a name of an online store or a video site is also excluded from the search result, and thus web pages of brick-and-mortar stores tend to be displayed at higher positions in the search result list. This allows a user to efficiently find a web page of a brick-and-mortar store selling merchandise the user wants to buy, from the list displayed as a result of the Internet search.

In the first embodiment described above, web pages are narrowed according to both an administrative district name and a name of an online store or a video site. Alternatively, the narrowing may be performed according to one of these. When the narrowing is performed according to one of these, many web pages other than web pages related to brick-and-mortar stores are removed from the search result, and thus a user is allowed to more efficiently find a web page of a brick-and-mortar store selling merchandise the user wants to get than is allowed by the conventional technique.

In the first embodiment described above, it is assumed by way of example that the search mode is set in advance to the normal search mode or the brick-and-mortar store search mode by a user by operating the operation unit 1. Alternatively, for example, when a user inputs a keyword in the search window by operating the operation unit 1, if the input keyword includes “store”, the search mode may be set to the brick-and-mortar store search mode, while if the input keyword does not include “store”, the search mode may be set to the normal search mode. This provides a benefit that each time a user performs an Internet search, the search mode is easily set to the normal search mode or the brick-and-mortar store search mode.

### Second Embodiment

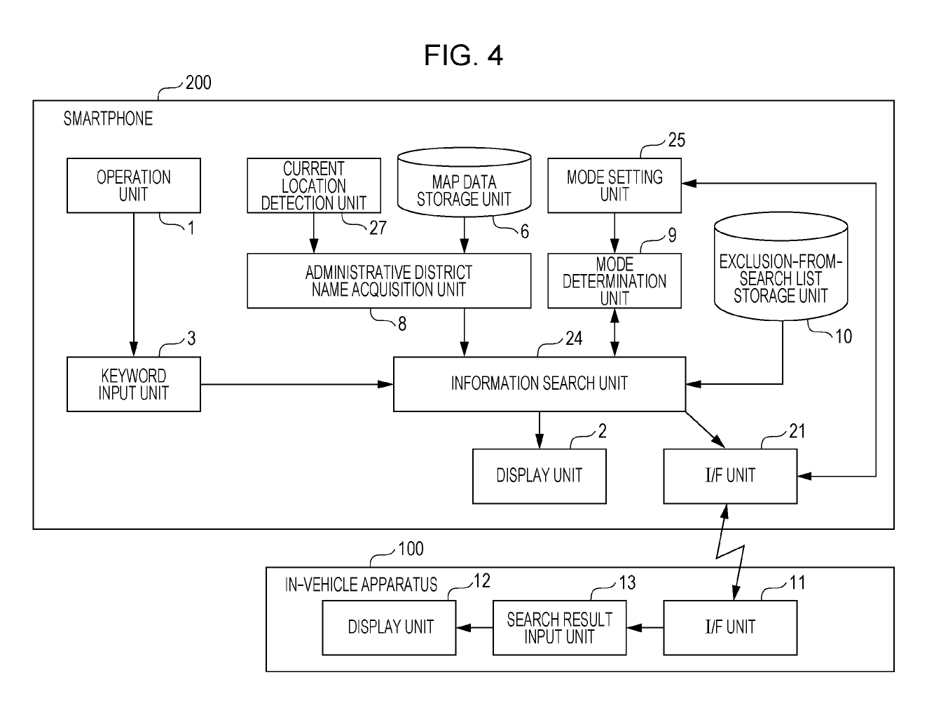

A second embodiment of the present invention is described below with reference to related drawings. FIG. 4 is a block diagram illustrating an example of a functional configuration of an Internet search apparatus according to the second embodiment. In FIG. 4, units similar to those in FIG. 1 are denoted by similar reference numerals, and a further duplicated description thereof is omitted.

In the second embodiment, it is assumed by way of example that the Internet search apparatus is installed in a smartphone 200. In the present example, the smartphone 200 is connected to the in-vehicle apparatus 100 via Bluetooth, and a result of a search performed on the smartphone 200 is displayed on both the in-vehicle apparatus 100 and the smartphone 200.

As illustrated in FIG. 4, the in-vehicle apparatus 100 includes an I/F unit 11, a display unit 12, and a search result input unit 13. On the other hand, the smartphone 200 is configured in a similar manner as the in-vehicle apparatus 100 including the functional units 1 to 10 illustrated in FIG. 1. However, in the smartphone 200 in the example illustrated in FIG. 4, the information search unit 4 illustrated in FIG. 1 is replaced by an information search unit 24 having a different function, the mode setting unit 5 is replaced by a mode setting unit 25 having a different function, and the current location detection unit 7 is replaced by a current location detection unit 27 having a different function. The smartphone 200 further includes an I/F unit 21.

The I/F unit 11 of the in-vehicle apparatus 100 and the I/F unit 21 of the smartphone 200 are wirelessly connected to each other such that communication via Bluetooth is allowed between them. The search result input unit 13 of the in-vehicle apparatus 100 receives a result of a search of web pages transmitted wirelessly from the information search unit 24 of the smartphone 200 via the I/F units 21 and 11. The received search result is displayed on the display unit 12.

In the smartphone 200, the mode setting unit 25 sets the normal search mode as the search mode in an initial state. When it is detected that the smartphone 200 is used in a vehicle, the mode setting unit 25 sets the brick-and-mortar store search mode as the search mode. More specifically, when the mode setting unit 25 detects that the I/F unit 21 is in a state in which the I/F unit 21 is wirelessly communicating with the I/F unit 11 of the in-vehicle apparatus 100 (that is, the in-vehicle apparatus 100 and the smartphone 200 are paired via Bluetooth), the mode setting unit 25 sets the brick-and-mortar store search mode as the search mode.

Note that regardless of whether the normal search mode or the brick-and-mortar store search mode is set as the search mode, the information search unit 24 performs an Internet search in a similar manner to a manner in which the information search unit 4 illustrated in FIG. 1 performs the Internet search. In this regard, the information search unit 24 has the same function as that of the information search unit 4. However, the information search unit 24 is different from the information search unit 4 in that in addition to displaying a search result on the display unit 2, the information search unit 24 wirelessly transmits the search result to the in-vehicle apparatus 100 via the I/F unit 21.

The current location detection unit 27 of the smartphone 200 detects the current location like the current location detection unit 7 of the in-vehicle apparatus 100 illustrated in FIG. 1. However, unlike the current location detection unit 7 of the in-vehicle apparatus 100, the current location detection unit 27 of the smartphone 200 does not include an autonomous navigation sensor although it includes a GPS receiver. That is, the current location detection unit 27 detects the current location using only the GPS receiver.

Also in the second embodiment configured in the above described manner, as in the first embodiment, the search result of web pages is narrowed according to the administrative district name, and furthermore any web page including a name of an online store or a video site is excluded from the search result. Thus many web pages of online stores or video sites are excluded from the search result, and web pages of brick-and-mortar stores tend to be displayed at high positions in the search result list. This allows a user to efficiently find a web page of a brick-and-mortar store selling merchandise the user wants to get, from the list displayed as a result of the Internet search.

In the second embodiment, the normal search mode may be automatically set as the search mode when the smartphone 200 is not connected to the in-vehicle apparatus 100 via a Bluetooth connection (that is, when the smartphone 200 and the in-vehicle apparatus 100 are not paired, which may occur, for example, when the smartphone 200 is used outside the vehicle), while in the case where the smartphone 200 is connected to the in-vehicle apparatus 100 via Bluetooth (that is, in a case where the smartphone 200 is used in the vehicle), the brick-and-mortar store search mode may be automatically set as the search mode. That is, in the second embodiment, the search mode is automatically switched without an operation by a user.

In the second embodiment described above, the mode setting unit 5 is replaced by the mode setting unit 25. However, the mode setting unit 5 may be used without being replaced by the mode setting unit 25. In this case, the normal search mode or the brick-and-mortar store search mode may be set as the search mode according to an operation performed on the operation unit 1 by a user.

In the example described above, it is assumed that the smartphone 200 includes the map data storage unit 6, the current location detection unit 27, and the administrative district name acquisition unit 8. However, the smartphone 200 is not limited to the configuration described above. For example, alternatively, the map data storage unit 6, the current location detection unit 27, and the administrative district name acquisition unit 8 may be disposed in the in-vehicle apparatus 100.

In this case, when the mode determination unit 9 determines that the brick-and-mortar store search mode is set as the search mode, the information search unit 24 may send inquiry to the in-vehicle apparatus 100 to acquire a name of an administrative district to which the current location belongs from the in-vehicle apparatus 100 via wireless communication. This makes it possible to practice the present embodiment even in a case where the smartphone does not have the navigation function.

### Third Embodiment

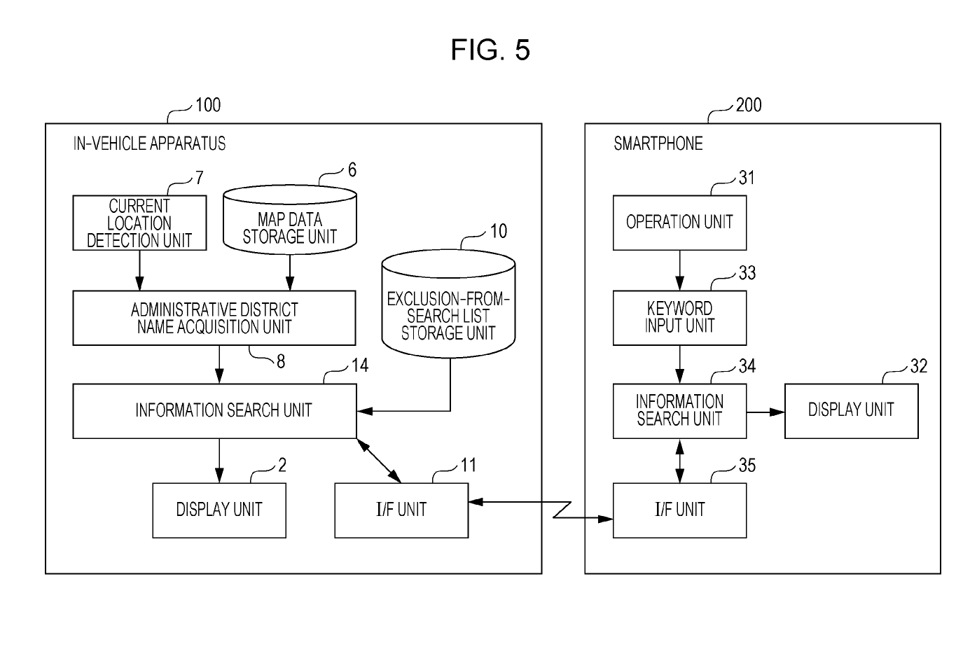

A third embodiment of the present invention is described below with reference to related drawings. FIG. 5 is a block diagram illustrating an example of a functional configuration of an Internet search apparatus according to the third embodiment. In FIG. 5, units similar to those in FIG. 1 are denoted by similar reference numerals, and a further duplicated description thereof is omitted.

In the third embodiment, the in-vehicle apparatus 100 and the smartphone 200 are wirelessly connected to each other via Bluetooth, and a result of a search of web pages is displayed on both the in-vehicle apparatus 100 and the smartphone 200 in a situation which the Internet search apparatus is installed in the in-vehicle apparatus 100.

In the third embodiment, both the in-vehicle apparatus 100 and the smartphone 200 have the Internet search function. However, only the in-vehicle apparatus 100 has a function of narrowing a result of a search of web pages according to an administrative district name or according to a name of an online store or a video site.

In the third embodiment, as illustrated in FIG. 5, the in-vehicle apparatus 100 includes, as functional units, a display unit 2, an information search unit 14, a map data storage unit 6, a current location detection unit 7, an administrative district name acquisition unit 8, an exclusion-from-search list storage unit 10, and an I/F unit 11. On the other hand, the smartphone 200 includes, as functional units, an operation unit 31, a display unit 32, a keyword input unit 33, an information search unit 34, and an I/F unit 35.

The I/F unit 11 of the in-vehicle apparatus 100 and the I/F unit 35 of the smartphone 200 are wirelessly connected to each other such that communication via Bluetooth is allowed between them. The operation unit 31 of the smartphone 200 is a unit used by a user to perform an operation related to Internet search. The operation unit 31 may be realized, for example, by a touch panel. For example, the operation unit 31 may be used to input a keyword used in the Internet search.

The display unit 32 is a unit for displaying information associated with Internet search. The display unit 32 may be realized, for example, by a liquid crystal display. For example, the display unit 32 displays a search window for inputting a keyword for Internet search or a result of the Internet search. The search window and the search result are both provided by the information search unit 34.

The keyword input unit 33 is a unit for inputting, to the information search unit 34, a keyword input in the search window by a user by operating the operation unit 31. The information search unit 34 searches for web pages on the Internet using the keyword input via the keyword input unit 33, and the information search unit 34 displays a list of retrieved web pages as a search result on the display unit 32. Note that the search result displayed on the display unit 32 is similar to that displayed in the normal search mode according to the first embodiment described above.

In a state in which the I/F unit 11 of the in-vehicle apparatus 100 and the I/F unit 35 of the smartphone 200 are connected (paired) via Bluetooth, the information search unit 34 transmits the search result of web pages according to the keyword to the in-vehicle apparatus 100 via the I/F unit 35 instead of displaying the search result on the display unit 32.

The information search unit 14 of the in-vehicle apparatus 100 receives a result of a search of web pages from the smartphone 200 via the I/F unit 11, and the information search unit 14 narrows the web pages by extracting web pages including the administrative district name from the search result and further removing web pages including a name of an online store or a video site from the search result.

More specifically, the information search unit 14 narrows the web pages by removing, from the list of web pages received from the smartphone 200, web pages which do not include, in their title or caption, the administrative district name acquired by the administrative district name acquisition unit 8, and web pages including, in their title or caption, a name of an online store or a video site stored in the exclusion-from-search list storage unit 10.

The information search unit 14 displays on the display unit 2 the list of web pages finally obtained after the narrowing, and the information search unit 14 transmits the resultant narrowed list of web pages to the smartphone 200 via the I/F unit 11. In the smartphone 200, this search result transmitted from the in-vehicle apparatus 100 is input to the information search unit 34 via the I/F unit 35 and displayed on the display unit 32. Note that the search result displayed on the display unit 2 and the display unit 32 is similar to that displayed in the brick-and-mortar store search mode according to the first embodiment described above.

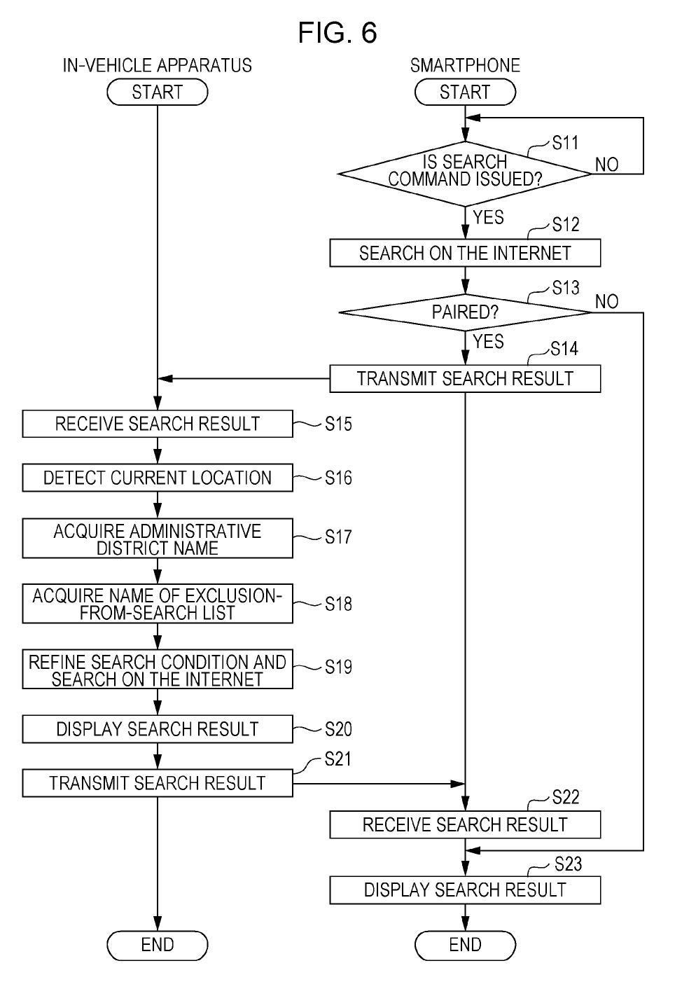

FIG. 6 is a flow chart illustrating an example of an operation of the in-vehicle apparatus 100 and the smartphone 200 configured in the above-described manner according to the third embodiment. The operation illustrated in the flow chart of FIG. 6 starts when a function of Internet search is started in the smartphone 200.

First, the keyword input unit 33 of the smartphone 200 determines whether a search command is issued by the information search unit 34 after a keyword is input in the search window displayed on the display unit 32 (step S11). In a case where the search command is not issued, the determination in step S11 is repeated. On the other hand, in a case where the search command is issued, the keyword input unit 33 supplies the input keyword to the information search unit 34 and notifies the information search unit 4 that the search command is issued.

In response to receiving the notification, the information search unit 34 performs an Internet search in the normal mode using the keyword input via the keyword input unit 33 (step S12). The information search unit 34 then determines whether the in-vehicle apparatus 100 and the smartphone 200 are paired by Bluetooth (step S13).

In a case where the in-vehicle apparatus 100 and the smartphone 200 are not paired by Bluetooth, the information search unit 34 displays a list of retrieved web pages as a search result on the display unit 32 (step S23). Thus, the operation illustrated in the flow chart of FIG. 6 is ended. On the other hand, in a case where the in-vehicle apparatus 100 and the smartphone 200 are paired, the information search unit 4 transmits the search result of web page to the in-vehicle apparatus 100 via the I/F unit 35 (step S14).

The in-vehicle apparatus 100 receives the search result transmitted from the smartphone 200 (step S15). In the in-vehicle apparatus 100, the current location detection unit 7 detects the current location of the vehicle at this particular time (step S16). The administrative district name acquisition unit 8 acquires an administrative district name to which the current location detected by the current location detection unit 7 belongs, based on map data stored in the map data storage unit 6, and the administrative district name acquisition unit 8 supplies the acquired administrative district name to the information search unit 14 (step S17).

Furthermore, the information search unit 14 acquires a name of online stores and a name of a video site specified as to be excluded from the exclusion-from-search list storage unit 10 (step S18). Thereafter, the information search unit 14 narrows the list of web pages received from the smartphone 200 based on the administrative district name acquired by the administrative district name acquisition unit 8 and names of online stores and video sites stored in the exclusion-from-search list storage unit 10 (step S19).

The information search unit 14 displays the list of resultant narrowed web pages on the display unit 2 (step S20), and transmits the list of resultant narrowed web pages to the smartphone 200 via the I/F unit 11 (step S21). In the smartphone 200, the I/F unit 35 receives the narrowed search result transmitted from the in-vehicle apparatus 100 (step S22), and the information search unit 34 displays the narrowed search result in the form of a list of web pages on the display unit 32 (step S23). Thus, the operation illustrated in the flow chart of FIG. 6 is ended.

Also in the third embodiment configured in the above described manner, as in the first embodiment, the search result of web pages is narrowed according to the administrative district name, and furthermore according to the names of online stores or video sites. Thus many web pages of online stores or video sites are removed from the search result, and web pages of brick-and-mortar stores tend to be displayed at higher positions in the search result list. This allows a user to more efficiently find a web page of a brick-and-mortar store selling merchandise the user wants to get, from the list displayed as a result of the Internet search.

In the third embodiment, in a case where the smartphone 200 is not connected to the in-vehicle apparatus 100 via Bluetooth (as in a case, for example, where the smartphone 200 is used outside the vehicle), it is possible to obtain a search result similar to that obtained when an Internet search is performed in the normal search mode according to the first embodiment described above. On the other hand, in a situation in which the smartphone 200 is connected to the in-vehicle apparatus 100 via Bluetooth (as in a case where the smartphone 200 is used in the vehicle), it is possible to obtain a search result similar to that obtained when an Internet search is performed in the brick-and-mortar store search mode according to the first embodiment described above. As described above, the third embodiment provides a benefit that the search mode is automatically switched without an operation by a user.

In the example described above, it is assumed that the in-vehicle apparatus 100 includes the information search unit 14 having only the function of narrowing a search result given from the smartphone 200. However, the present embodiment is not limited to such a function. For example, the in-vehicle apparatus 100 may also have a function of the operation unit 1 and function of the keyword input unit 3 illustrated in FIG. 1, and furthermore, the information search unit 14 may also have a function of the information search unit 4 illustrated in FIG. 1 such that the in-vehicle apparatus 100 is capable of performing an Internet search by itself even in a situation in which the smartphone 200 is not connected to the in-vehicle apparatus 100. In this case, it is desirable that the in-vehicle apparatus 100 also includes the mode setting unit 5 (or the mode setting unit 25) and the mode determination unit 9.

In the examples according to the first to third embodiments, it is assumed to completely remove, from the search result, web pages that do not include a name of an administrative district to which the current location of the vehicle belongs and web pages including a name of an online store or a video site specified to be excluded. However, the manner of exclusion is not limited to that disclosed in these examples. For example, exclusion of web pages may be applied only to a range from a top position to an n-th position in the list of retrieved web pages.

### Fourth Embodiment

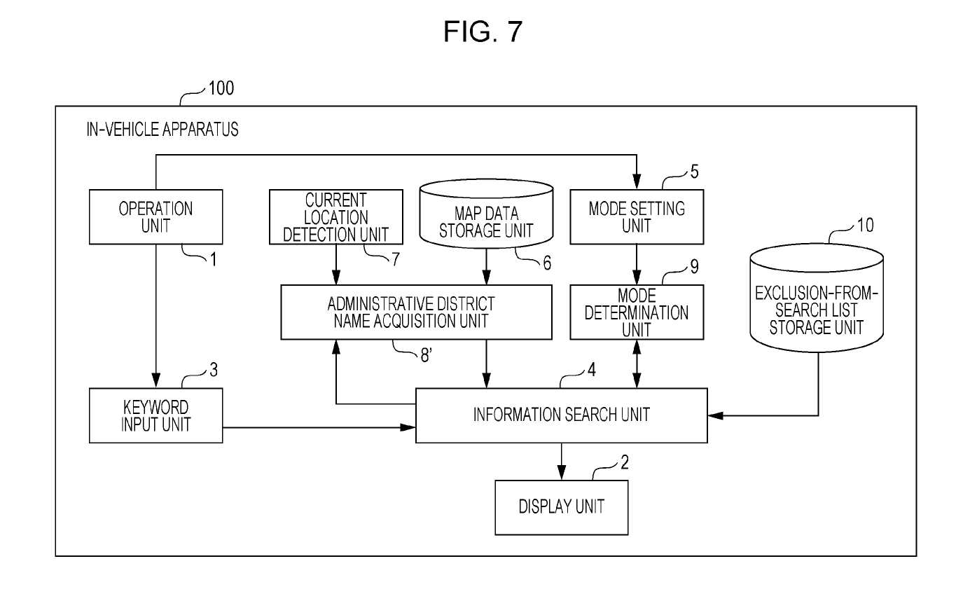

Next, a fourth embodiment of the present invention is described below with reference to related drawings. FIG. 7 is a block diagram illustrating an example of a functional configuration of an Internet search apparatus according to the fourth embodiment. In FIG. 7, units similar to those in FIG. 1 are denoted by similar reference numerals, and a further duplicated description thereof is omitted.

In the Internet search apparatus according to the fourth embodiment, as illustrated in FIG. 7, the administrative district name acquisition unit 8 illustrated in FIG. 1 is replaced by an administrative district name acquisition unit 8′ having a different function. The administrative district name acquisition unit 8′ is configured to acquire a name of an administrative district to which a facility belongs that is related to a keyword input via the keyword input unit 3 and is located closest to the current location detected by the current location detection unit 7 among detected facilities.

Facilities related to the keyword refer to facilities described in web pages or their title or caption retrieved as a result of search performed according to a combination of keywords including an original keyword and a name of administrative district to which the current location belongs. In a case where a facility name is input as the keyword via the keyword input unit 3, a title or a caption of each retrieved web page includes the same facility name as that given as the input keyword. In a case where merchandise name is input as the keyword, a title or a caption of each retrieved web page includes a facility name that deals in the merchandise as illustrated in FIG. 2B. The administrative district name acquisition unit 8′ detects facilities corresponding to the facility name based on the map data and acquires a name of an administrative district to which a facility located closest to the current location belongs.

More specifically, when a keyword is input via the keyword input unit 3, the administrative district name acquisition unit 8′ first acquires, from the map data storage unit 6, a name of administrative district to which the current location detected by the current location detection unit 7 belongs as in the first embodiment. The information search unit 4 adds the administrative district name acquired by the administrative district name acquisition unit 8′ to the input keyword and searches for web pages on the Internet.

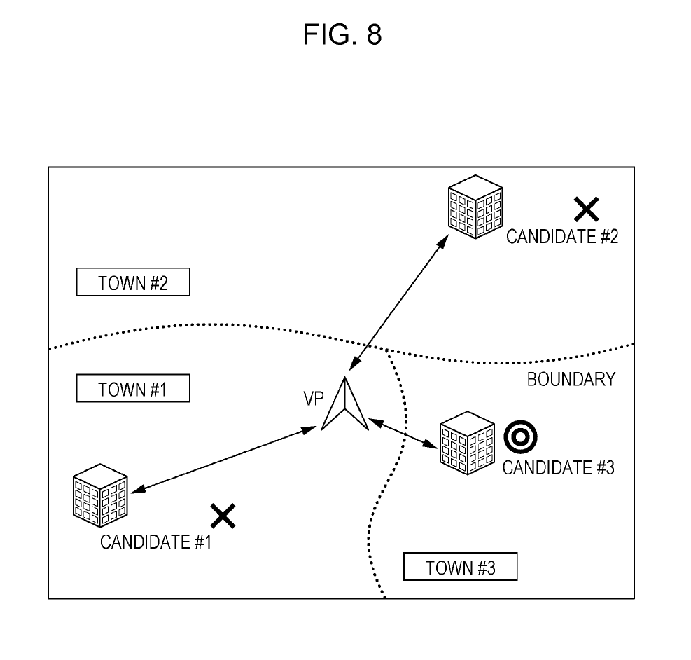

The administrative district name acquisition unit 8′ then extracts facility names from titles or captions of web pages retrieved by the information search unit 4, and detects facilities corresponding to the extracted facility names based on the map data stored in the map data storage unit 6. Note that in the present description, the term “facility” is used to describe wide variety of facilities including stores, shops, institutions, or the like, and thus the “facility” is a generic expression thereof. In a case where a plurality of facilities (candidates #1 to #3 in the example illustrated in FIG. 8) related to the input keyword are detected as in the case illustrated in FIG. 8, the administrative district name acquisition unit 8′ identifies a facility located closest to the current location VP detected by the current location detection unit 7 (the candidate #3 is identified in the example illustrated in FIG. 8), and the administrative district name acquisition unit 8′ acquires a name of an administrative district where the identified facility is located.

The information search unit 4 again searches for information on the Internet according to keywords including the original input keyword plus a new keyword representing the administrative district name acquired by the administrative district name acquisition unit 8′, and the information search unit 4 displays a list of web pages obtained as a result of the search on the display unit 2. Note that the information search unit 4 displays the list of retrieved web pages excluding web pages that include a name of an online store or a video site stored in the exclusion-from-search list storage unit 10.

Alternatively, the information search unit 4 may provide a search result that any web page including no description, in its title or caption, of an administrative district name acquired by the administrative district name acquisition unit 8′ in the above-described manner is removed from the web pages obtained via the search based on the input keyword, and any web page including a description, in its title or caption, of a name of an online store or a video site stored in the exclusion-from-search list storage unit 10 is further removed, and a result is displayed in the form of a list on the display unit 2.

In a case where brick-and-mortar stores that sell merchandise are located over a plurality of administrative districts as in the example illustrated in FIG. 8, when the vehicle is located close to a boundary of an administrative district, there is a possibility that the current location is closer to a brick-and-mortar store located in another administrative district adjacent to the administrative district to which the current location belongs than to a brick-and-mortar store located in the administrative district to which the current location belongs. According to the fourth embodiment, a web page of a brick-and-mortar store located closest to the current location and including a name of an administrative district in which the brick-and-mortar store is located is allowed to be displayed at a high position in the list of retrieved web pages. This allows a user to efficiently find a web page of a brick-and-mortar store that sells merchandise the user wants to get and that is located closest to the current location from the list of web pages displayed as a result of the Internet search.

In the fourth embodiment described above, the configuration illustrated in FIG. 1 is modified. Alternatively, the fourth embodiment may be applied to a modification of the configuration illustrated FIG. 4 or that illustrated in FIG. 5.

### Fifth Embodiment

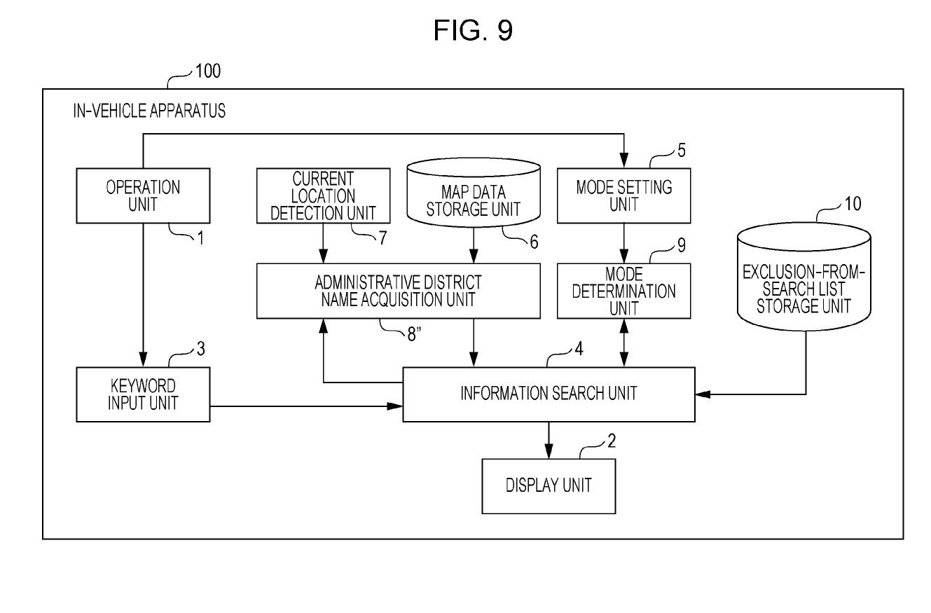

Next, a fifth embodiment of the present invention is described below with reference to related drawings. FIG. 9 is a block diagram illustrating an example of a functional configuration of an Internet search apparatus according to the fifth embodiment. In FIG. 9, units similar to those in FIG. 1 are denoted by similar reference numerals, and a further duplicated description thereof is omitted.

In the Internet search apparatus according to the fifth embodiment, as illustrated in FIG. 9, the administrative district name acquisition unit 8 illustrated in FIG. 1 is replaced by an administrative district name acquisition unit 8″ having a different function. The administrative district name acquisition unit 8″ acquires a name of an administrative district to which facilities belong that are related to a keyword input via the keyword input unit 3 and that are located within a predetermined range of distance from a guidance route extending ahead from the current location detected by the current location detection unit 7.

Facilities related to the keyword are similar to those according to the fourth embodiment described above. That is, the facilities are detected in titles or captions of web pages that are retrieved as a result of a search performed by the information search unit 4 according to keywords including an original input keyword plus a name of administrative district where the current location is located.

More specifically, when a keyword is input via the keyword input unit 3, the administrative district name acquisition unit 8″ first acquires, from the map data storage unit 6, a name of administrative district to which the current location detected by the current location detection unit 7 belongs as in the first embodiment. The information search unit 4 adds the administrative district name acquired by the administrative district name acquisition unit 8″ to the original input keyword and searches for web pages on the Internet according to the resultant combination of keywords.

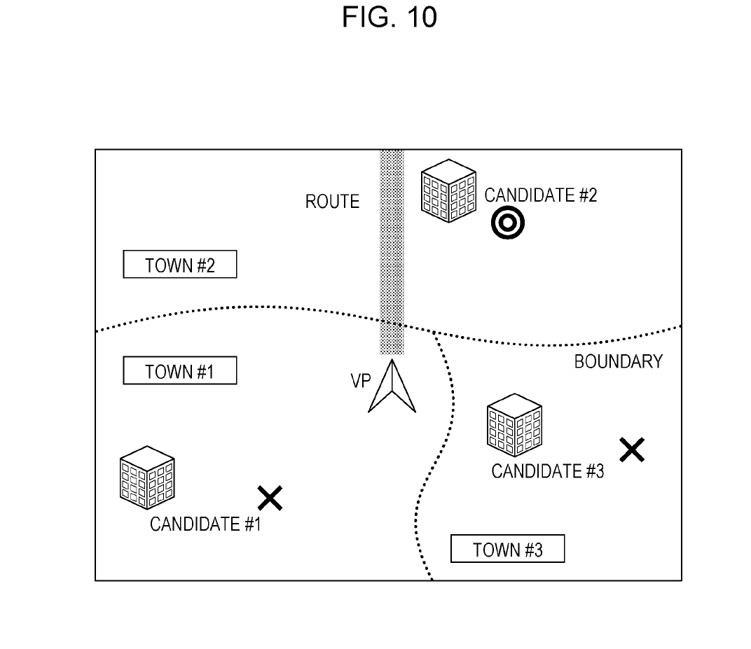

The administrative district name acquisition unit 8″ then extracts facility names from titles or captions of web pages retrieved by the information search unit 4, and detects facilities corresponding to the extracted facility names based on the map data stored in the map data storage unit 6. The administrative district name acquisition unit 8″ acquires a name of an administrative district including facilities (candidate #2 in the example illustrated in FIG. 10) located within a predetermined range of distance from a guidance route extending ahead from the current location VP detected by the current location detection unit 7 as illustrated in FIG. 10.

The information search unit 4 again searches for information on the Internet according to the combination of keywords including the original input keyword and the administrative district name acquired by the administrative district name acquisition unit 8″, and the information search unit 4 displays a list of web pages obtained as a result of the search on the display unit 2. Note that the information search unit 4 displays the list of retrieved web pages excluding web pages that include a name of an online store or a video site stored in the exclusion-from-search list storage unit 10.

Alternatively, the information search unit 4 may display the list of web pages such that any web page in which an administrative district name acquired by the administrative district name acquisition unit 8″ in the above-described manner is not included in its title or description is removed from the web pages obtained via the search based on the input keyword, and any web page in which a name of an online store or a video site stored in the exclusion-from-search list storage unit 10 is included in its title or caption is further removed, and a result is displayed in the form of a list on the display unit 2.

According to the fifth embodiment, as described above, when there are a plurality of facilities related to the input keyword, administrative districts which the guidance route is not supposed to pass through are excluded, which allows it to display the search result such that web pages of brick-and-mortar stores including a description of name of an administrative district located close to the guidance route are displayed at high positions of the list. This allows a user to efficiently find a web page of a brick-and-mortar store that sells merchandise the user wants to get and that is located closest to a guidance route, from the list of web pages displayed as a result of the Internet search.

In the fifth embodiment described above, the configuration illustrated in FIG. 1 is modified. Alternatively, the fourth embodiment may be applied to a modification of the configuration illustrated FIG. 4 or that illustrated in FIG. 5.

Although the fourth embodiment and the fifth embodiment have been described above separately, the fourth and fifth embodiments may be combined. For example, when a guidance route is not defined, the fourth embodiment may be employed, while the fifth embodiment may be employed when a guidance route is defined.

Although preferred embodiments have been described in detail, the present invention is not limited to these specific embodiments of the present invention. Rather, various modifications and changes can be made without departing from the scope of the present invention as described in the accompanying claims. Accordingly, all such modifications are intended to be included within the scope of this invention as defined in the following claims.

What is claimed is:

1. An Internet search apparatus comprising:
a current location detection unit configured to detect a current location;
an administrative district name acquisition unit configured to acquire, based on map data, a name of an administrative district satisfying a predetermined condition for the detected current location; and
an information search unit configured to perform an Internet search, and display a search result in the form of a list such that a displayed web page that does not include the acquired administrative district name, is excluded.

2. The Internet search apparatus according to claim 1, wherein the administrative district name acquisition unit acquires a name of an administrative district which corresponds to or encompasses the detected current location.

3. The Internet search apparatus according to claim 1, wherein the administrative district name acquisition unit acquires a name of an administrative district to which a facility belongs, the facility being located closest to the detected current location among all retrieved facilities related to a keyword input in a search window of a search engine.

4. The Internet search apparatus according to claim 1, wherein the administrative district name acquisition unit acquires a name of an administrative district to which a facility belongs, the facility being related to a keyword input in a search window of a search engine, and being located within a predetermined distance from a guidance route extending from the detected current location.

5. The Internet search apparatus according to claim 1, wherein the information search unit searches for information on the Internal using a combination of keywords including a keyword input into a search window of a search engine and a keyword provided as the acquired administrative district name; and wherein the information search unit displays a list of retrieved web pages as a search result.

6. The Internet search apparatus according to claim 1, further comprising a mode determination unit configured to determine whether a brick-and-mortar store search mode is set, the brick-and-mortar store search mode causing the search to be directed to brick-and-mortar stores selling merchandise; and
wherein if the brick-and-mortar store search mode is set as the search mode, the information search unit displays a search result in the form of a list that excludes web pages that do not include the acquired administrative district name.

7. The Internet search apparatus according to claim 6, further comprising a mode setting unit configured to set the brick-and-mortar store search mode as the search mode when it is detected that the Internet search apparatus is in a vehicle.

8. The Internet search apparatus according to claim 1, wherein the information search unit displays the search result in the form of a list such that a web page including an online store name is further excluded.

9. The Internet search apparatus according to claim 7, wherein the information search unit displays the search result in the form of a list such that a web page that includes a name of a video site is further excluded.

10. An Internet search apparatus comprising:
a mode determination unit configured to determine whether a brick-and-mortar store search mode is set as a search mode to search for a brick-and-mortar store selling merchandise; and
an information search unit configured such that if the brick-and-mortar store search mode is set as the search mode, the information search unit displays a search result in the form of a list that excludes a web page which includes an online store name.

11. The Internet search apparatus according to claim 10, wherein the information search unit displays the search result in the form of a list such that a web page including a name of a video site is further excluded.

12. The Internet search apparatus according to claim 10, further comprising:
a current location detection unit configured to detect a current location;
an administrative district name acquisition unit configured to acquire, based on map data, a name of an administrative district satisfying a predetermined condition corresponding to the current location; and
wherein if the brick-and-mortar store search mode is set as the search mode, the information search unit displays a search result in the form of a list that excludes web pages that do not include the administrative district name.

13. The Internet search apparatus according to claim 12, wherein the administrative district name acquisition unit acquires a name of an administrative district which corresponds to or encompasses the detected current location.

14. The Internet search apparatus according to claim 12, wherein the administrative district name acquisition unit acquires a name of an administrative district to which a facility belongs, the facility being located closest to the detected current location among all retrieved facilities related to a keyword input in a search window of a search engine.

15. The Internet search apparatus according to claim 12, wherein the administrative district name acquisition unit acquires a name of an administrative district to which a facility belongs, the facility being related to a keyword input in a search window of a search engine, and being located within a predetermined distance from a guidance route extending from the detected current location.

16. The Internet search apparatus according to claim 12, wherein if the brick-and-mortar store search mode is set as the search mode, the information search unit searches for information on the Internal using a combination of keywords including a keyword input in a search window of a search engine and a keyword provided as the acquired administrative district name, and the information search unit displays a list of retrieved web pages as a search result.

17. The Internet search apparatus according to claim 10, further comprising a mode setting unit configured to set the brick-and-mortar store search mode as the search mode if the Internet search apparatus is in a vehicle.
